(19) United States
(12) Patent Application Publication
(10) Pub. No.: US 2018/0092344 A1
(43) Pub. Date: Apr. 5, 2018

(54) SYSTEM AND METHOD FOR LURING AND TRAPPING BLOOD-SEEKING AND BITING INSECTS INCLUDING HEMATOPHAGOUS ARTHROPODS

(71) Applicant: George R. Tyler, Arlington, VA (US)

(72) Inventor: George R. Tyler, Arlington, VA (US)

(21) Appl. No.: 15/286,167

(22) Filed: Oct. 5, 2016

(51) Int. Cl. A01M 1/02; A01M 1/10; A01M 1/06

(52) U.S. Cl. CPC A01M 1/023; A01M 1/06; A01M 1/106

(57) ABSTRACT

A system, and method for trapping biting or blood-seeking flying insects, including a host-seeking stage module configured to trap target insects in a host-seeking stage thereof, and comprising a lure including an olfactory cue configured to attract the target-insects in the host-seeking stage, and a first suction mechanism configured with suction to suck the target insects in the host-seeking stage near the lure into a first container; and a ovipository stage module configured to trap target insects in an ovipository stage thereof, and comprising a water reservoir configured to attract gravid females seeking to deposit eggs thereon, and a second suction mechanism configured with suction to suck the gravid females from the water reservoir into a second container.

### BACKGROUND OF THE INVENTION

### Field of the Invention

The present invention generally relates to systems and methods for luring and trapping insects, and more particularly to a method and system for luring and trapping flying and biting insects, such as midges, blood-seeking insects, such as mosquitoes, and the like.

### Discussion of the Background

In recent years, various systems for systems and methods for luring and trapping insects have been devised. However, such systems and methods are not robust with respect to luring and trapping efficiency of flying and biting insects, and the like.

### SUMMARY OF THE INVENTION

Therefore, there is a need for a method and system that addresses the above and other problems. The above and other problems are addressed by the illustrative embodiments of the present invention, which provide a robust and efficient system and method for luring and trapping flying and biting insects, and the like.

Accordingly, in illustrative aspects of the present invention there is provided a system, and method for trapping biting or blood-seeking flying insects, including a host-seeking stage module configured to trap target insects in a host-seeking stage thereof, and comprising a lure including an olfactory cue configured to attract the target-insects in the host-seeking stage, and a first suction mechanism configured with suction to suck the target insects in the host-seeking stage near the lure into a first container; and a ovipository stage module configured to trap target insects in an ovipository stage thereof, and comprising a water reservoir configured to attract gravid females seeking to deposit eggs thereon, and a second suction mechanism configured with suction to suck the gravid females from the water reservoir into a second container.

The lure of the host-seeking stage module includes CO2 with a plurality of volatiles mimicking human or mammalian breath produced as a by-product of yeast fermentation of sugars.

The system and method further include a solar power system configured to power the first and second suction mechanisms.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative diagram depicting the invention in a possible two module format and method to trap biting and blood-seeking insects, usable in combination or alone;

FIG. 2 is diagram that depicts one possible configuration of an illustrative interior of the host-seeking trapping housing module; and

FIG. 3 is a diagram that depicts a top view of one possible configuration of an illustrative exterior of an ovipository-seeking trapping module.

### DETAILED DESCRIPTION OF THE PREFERRED EMBODIMENTS

An illustrative target-insect trapping system and method is described. In the following description, for purposes of explanation, numerous specific details are set forth in order to provide a thorough understanding of the present invention. It is apparent to one skilled in the science, however, that the present invention may be practiced without these specific details or with an equivalent arrangement or with one module deployed in the absence of the other. In some instances, well-known devices and structures are shown in block diagram in order to avoid unnecessarily obscuring the present invention.

The present invention includes recognition that flying insects are ubiquitous, living and breeding in close proximity to human beings in every climate globally. This proximity is so pronounced that a large number of insects such as mosquitoes have evolved specifically to include mammalian interaction as one element of their life cycle. This interaction of biting frequently involves obtaining a blood meal, an encounter which too frequently involves disease transmission involving parasites and pathogens, including deadly ones. Some of the targets utilize blood meals that stimulate ovarian development followed by pregnancy and thence egg-laying.

The behavior of biting and of blood-seeking species of insects (e.g., including hematophagous arthropods) are an annoyance and can impose a considerable disease burden on human beings. This annoyance and burden peak during summer months in northern climates but exists year round in warmer regions, especially tropical and equatorial regions. An example of the disease burden is that opportunistic anthropophilic and zoophilic mosquito species are a prime disease vector for malaria, one of the most pervasive and deadliest of all infectious diseases.

Efforts to stem the annoyance and disease burden of biting and of blood-seeking insects are age old, and have benefitted from extensive public research. Recent decades have seen development of a variety of insecticides, for example. They are expensive, pose the risk of environmental degradation, harm benign insects and other wildlife and pose danger to human beings, especially pregnant women, the young, elderly and those with compromised immune systems. For these reasons, alternative methods to expand on mature technologies such as window and door screens have been pursued with public sector support to limit exposure to target-insects, include bed nets, chemical repellants and insect traps. Experts also routinely admonish the public to eliminate standing water near habitation including emptying old tires, flower pots and the like of water, and to apply insecticides to ponds and other still-water reservoirs. That is because the first stage of the mosquito life cycle, for example, involves blood-engorged pregnant females (e.g., gravids) depositing eggs in standing water where they form rafts before evolving to the second or larva stage.

Traps were originally devised as tools to capture vectors for scientific evaluation involving infection disease transmission, typically funded by the public sector or nonprofit foundations. Private enterprise has drawn on the tools and modalities devised by these entomologists in developing products for commercial markets.

Traps devised for scientific exploration or for commercial opportunity are ineffective in the control or eradication of biting and blood-seeking insects, especially outdoors where target populations are widely dispersed over the landscape. They have failed to supplant insecticide spraying as the gold standard for hematophagous arthropods eradication, for example. Indeed, the trapping modality is only a fifth line remediation option for control of target-insects, rarely utilized where insecticide spraying is feasible, in place of screening, bed netting, or chemical repellants.

Traps are a fifth line remediation option because their effectiveness is compromised by three major deficiencies. They are too-often bypassed by biting and blood-seeking target-insects because of (A) poor trap design and (B) reliance on insect attractant (e.g., lures) modalities that are ineffective (and e.g., too expensive for regions most at risk such as equatorial African and central America). Traps are poorly designed for two reasons. First, none is effective during both daytime and nighttime. Second, traps are incapable of trapping target-insects over their entire life-cycle; instead, traps are designed to either (but e.g., not both) target-insects that are seeking hosts for blood meals or during the subsequent period a few days later after ovulation and fertilization when, as gravids, they seek still water sites called oviposition to lay eggs. Mosquitoes, for example, ovulate once they have obtained two or three blood meals in the host-seeking stage, most becoming pregnant soon after, leading to their subsequent ovipository-seeking behavior. To summarize, the four most effective armamentarium are insecticide spraying, screens, bednets and chemical repellants; those methods are most responsible for lowering the incidence of insect biting, including the decline in malaria by 29 percent worldwide in the last decade or so, for example. But rising drug- and insecticide-resistance threatens that progress. More robust and effective traps are needed, especially ones able to target behaviors common during more extended portions of target-insect life cycles. In detail, their present deficiencies are:

Design Deficiency:

Conventional trap designs (e.g., called counter-flow or suction models) feature an intake aperture at one height within six feet of the ground. Target-insects venturing within inches of an aperture are suctioned into a cage or net by action of fan. These are small fans: the two most popular commercial traps utilize 12 volt fans, 110-120 cm square, drawing 0.55 amps or less. Biting and blood-seeking insects are extremely light, unable to resist air flows exceeding 2-3 mph; they are suctioned into either a capture basket where they die of dehydration over several days or are dismembered as they pass through the fan itself. This design lacks robustness. It minimizes trapping success during the host-seeking phrase because targets can be captured at just one height. That is problematic because target-insects fly close to the ground during daylight hours when winds are relatively brisk. They are more adventuresome and active after dusk when traps with higher apertures would be more effective. Thus, single height trap designs are ineffective for as much as half of every 24 hours.

Ineffective Attractants.

Attractants utilized to lure target-insects including hematophagous arthropods within range of the inflow aperture of traps are typically chemical compounds designed to mimic mammalian odor, particularly skin volatiles. Considerable evidence has emerged from semi-field and field testing by public agencies, academics and others that insect traps for target-insects are more effective when the lure package includes carbon dioxide (CO2), a major component (e.g., 5%, 250 ml/min) of expelled human and animal breath. Indeed, CO2 is considered an essential olfactory cue for trapping a wide range of target-insects, a number of which have been found to detect it at distances up to 30 feet. Other lures (e.g., body odor, light and dark contrast, humidity, heat) may then be utilized in varying combinations to lure targets closer to the suctioning aperture. However, the efficacy of CO2 varies greatly according to its provenance. Conventional commercial traps obtain CO2 as a by-product of the combustion of hydrocarbons (e.g., typically propane) or as a pure (e.g., >99.9%) gas sold commercially in pressurized gas canisters. Neither source produces CO2 resembling the profile of volatiles in human breath. As international scientific evaluation of the commercial CO2 available in pressurized canisters has documented, it is a less effective lure than CO2 produced through the yeast-fermentation of sugars. As one research team reported in a malaria journal (see, e.g., Smallegange, et al., “Sugar-fermenting yeast as an organic source of carbon dioxide to attract the malaria mosquito Anopheles gambiae, Malaria Journal, 9:292; Oct. 25, 2010), for example, yeast-produced CO2 caught “significantly more [mosquitoes] than traps baited with industrial CO2, both in the laboratory and semi-field.” Indeed, CO2 produced from yeast fermentation includes more than 20 organic volatiles found in human emanations that are lacking in industrial CO2. Moreover, CO2 from industrial gases or hydrocarbons such as propane packaged in pressurized steel cylinders is expensive. And, it requires the addition of costly flow meters to regulate their highly variable release rate; such meters are sensitive to dust or high humidity and entail connections subject to leaks.

The relative efficacy of CO2 from industrial gases compared to yeast fermentation as attractants for trapping has been examined in a number of settings including Japan, Kenya and Malaysia by a wide variety of international scholars and scientists, funded by institutions such as the U.S. National Institutes of Health. Yeast fermentation has proved to be twice as effective in luring mosquitoes to suction traps as has industrial CO2, capturing a high 51.6 percent of released insect vectors in scientific trials. The scientific consensus on this issue is reflected in this quote from an analysis appearing in the above-noted malaria journal:

“Traps baited with yeast-producing CO2 caught significantly more mosquitoes than unbaited traps and also significantly more than traps baited with industrial CO2, both in the laboratory and in semi-field . . . Yeast-producing CO2 can effectively replace industrial CO2 . . . [in] sustainable mass-application.”

Traps operate during less than one-half of the life cycle of target-insects. Blood-seeking female insects such as mosquitoes engaged in host-seeking behavior to obtain blood meals 2 or 3 times; they utilize CO2 and other odors, plus heat and perhaps light contrast to hone in on mammals. Once engorged, they ovulate, with most females subsequently becoming pregnant within a handful of days. The gravids then seek ovipositories, typically still water ponds, wetlands or puddles in which to lay eggs. Virtually all traps presently target the host seeking behavior only, while few instead designed for the ovipository-search behavior of gravids. However, none target both.

The invention reflects recognition that traps to capture biting and blood-seeking insects perform poorly. It rectifies their deficiencies with a method and system that addresses ineffective designs, relatively ineffective CO2 lures and their failure to target extensive periods during the daily cycle or during the life cycle of the target-insects.

Through a design innovation, the novel invention as much as doubles the daily opportunity to trap target-insects engaged in host-seeking behavior. Trapping is typically reliant on fans creating a suction through tubing. All traps at present target higher flying insects with suction apertures above 2-3 feet, or lower flying insects with apertures open at lower heights. That choice limits trapping opportunities because target-insects fly low during daylight hours and higher after dusk. The invention addresses this shortcoming with an advantageous novel design of two suction apertures at different heights, one low to the ground and another higher. This novel design is significantly more robust than conventional trapping devices, as much as doubling the opportunities they provide presently by operating effectively in both daylight and dark.

Traps are ineffective without dispersing olfactory cues that mimic those utilized by biting and blood-seeking insects to locate, identify and hone-in on suitable hosts. The key long-distance cue is carbon dioxide gas which is expelled by mammals in quantity. Scientific investigations have determined that fermented CO2 from sugars including but not limited to glucose, fructose, molasses and sucrose include a plurality of volatiles (e.g., up to or more than 20 volatiles) commonly found in the CO2 expelled by humans. CO2 produced through combustion or obtained from commercial gas stocks lack those volatiles, rendering them relatively ineffective as cues in traps for luring target-insects. The invention utilizes a novel design that permits users to utilize CO2 gas from fermentation; they can for convenience optionally utilize pressurized CO2 gas from commercial sources instead. The former is also a sustainable option in developing nations where CO2 from combustion or pressurized CO2 tanks are both inconvenient and expensive.

Target-insects in their host-seeking stage are differentially attracted to heat as a cue identified with mammals. The invention can accommodates that phenomenon through the optional use of heating pads in the host-seeking trapping module.

While gravid biting and blood-seeking insects eagerly seek ovipository sites, few traps are designed to operate during this stage of their life cycle. And none target both this stage and the prior host-seeking stage. The invention resolves this limited applicability by utilizing two modules, thereby expanding target-insect exposure to enhanced trapping during both the host-seeking and ovipository-seeking stages of their life cycle. The latter is a novel separate module design featuring a water container located adjacent and attached to one or more suction apertures.

Odorant chemical compounds in addition to CO2 can be accommodated by the invention as lures for each of the life-cycle stages. In addition to a variety of chemical lures, for example, dirty socks considerably enhance the efficacy of lures during the host-seeking stage. The olfactory and visual cues appropriate for attracting targets to the vicinity of the suction aperture(s) during the host seeking stage may differ from those considered effective during the ovipository-search stage. The latter include water vapor, the presence of bacteria, relative humidity, chemical formulations and perhaps soil infusions and other attractants, possibly enhanced by salting to increase the release of volatiles from the organic substrates. Continuing scientific investigation can identify additional new attractants that can be subsequently utilized in conjunction with the invention.

An advantageous differential lure is site landscaping—the degree of openness at the trap site. Host-seeking behavior features a preference for shady vegetative settings while ovipository-seeking behavior favors open spaces including visual cues featuring pools of water. Another novel design feature of the invention is to accommodate this scientific understanding by accommodating placement of the water/trapping module for the ovipository-seeking stage at some distance from the module including the host-seeking stage trap.

The invention accommodates the use of sterile water (e.g., perhaps preferred by malarial vectors) or unsterile water. It also accommodates the use of any suitable substance(s) as attractants in or on the water, and the use of pesticides or other substances to ensnare gravids coming in contact with the water or that kills their eggs or larvae deposited in the water.

The invention utilizes low-voltage electricity to power its fans and heating pads (and e.g., regulate CO2 emissions if needed). The electricity can be supplied from stepped-down low-voltage household current, obtained from an optional solar array for off-grid application or from batteries. Solar arrays include photovoltaic cells, batteries and controllers, and may be linked by wiring to the host-seeking module and the ovipository-seeking module. Since the module for the ovipository-seeking stage featuring a water repository can preferentially be sited in an open area, any array can optionally be sited nearby to maximize solar radiation.

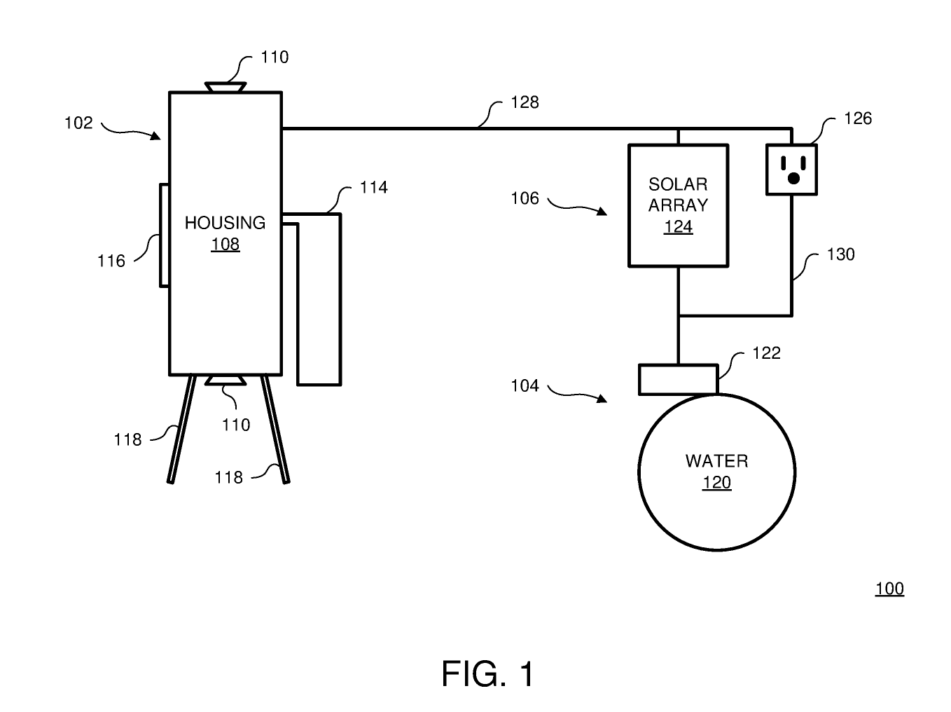

Referring now to the figures, wherein like reference numerals designate identical or corresponding parts throughout the several views, and more particularly in FIG. 1 the elements of the novel trapping system and method are presented in an illustrative fashion. The host-seeking trapping module 102 (e.g., including a housing 108), the ovipository-seeking trapping module 104 (e.g., whose presence in the invention may be optional) and the power supply which by way of illustration includes a solar array 106 or alternatively low voltage household current 126 including transformer to produce 12 volts of direct current to the module(s) 102 and 104.

Low-voltage household current or the solar array 106 can be wired via line 128 to the host-seeking module 102 or wired via line 130 to the ovipository-seeking module 104, or to both. The solar array 106 includes photovoltaic cells 124 and can also include battery and necessary controller to produce sufficient power for a designated time period of darkness or cloud cover.

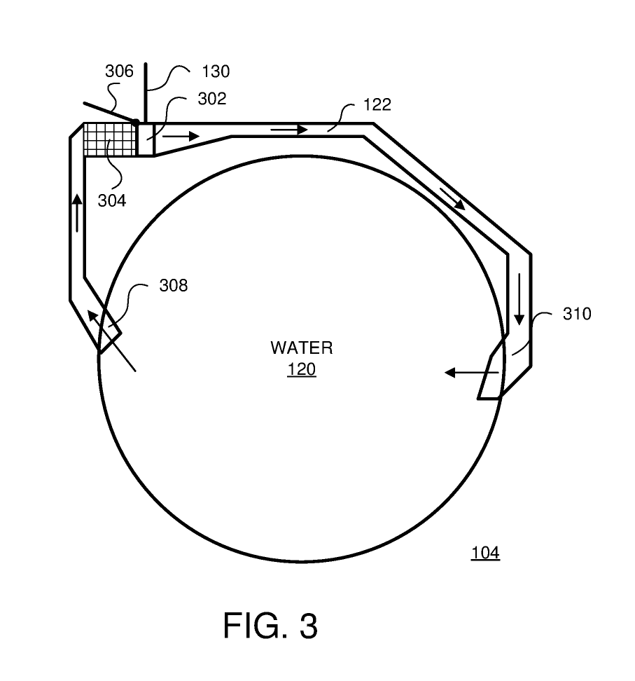

The host-seeking trapping module 102 can be encased in a housing 108 which can be of any shape, but for illustrative purposes is presented as a cylinder with circular openings on top and on bottom serving as suction apertures 110. The module 102 can be supported by legs 118, with access panel(s) 116, and with an option CO2 generator 114 attached or nearby. The ovipository-seeking trapping module 104 can include chamber(s) 122 as further described with respect to FIG. 3.

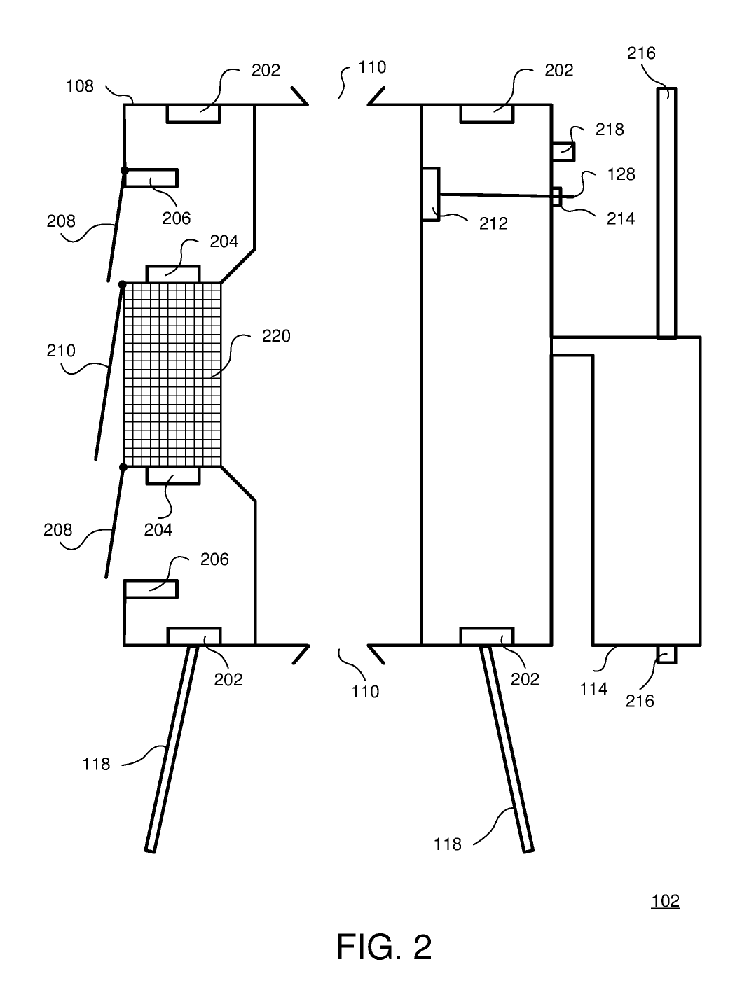

The suction apertures 110 of the module 102 are connected in an illustrative arrangement in FIG. 2 with a cylindrical tube extending vertically through the module 102 from top to bottom. A target-insect collection chamber 220 is connected to the central tube such that a fan or fans 204 generate an inward airflow through the suction apertures 110 and into the collection chamber 220, where target-insects are drawn and retained by the air draft. The collection chamber 220 can include a cage, bag or other device open at one end that can be removed for cleaning as appropriate through an access point 210 of indeterminate design.

The fan or fans 204 in FIG. 2 expel air suctioned through the collection system 220 into the host-seeking module housing 108 and thence out of the module 102. A lure or lures 206 capable of providing cues as an attractant appropriate for the target-insects can be sited near or amid the expelled air flow, enabling dispersion with such airflow. If located within the module housing 108, access to the lure or lures 206 as appropriate for placement can be via an access point(s) 208. Heating pads and thermostat controller 202, if needed, can be utilized as appropriate to generate heat as an additional lure, the pads and controller 202 sited where appropriate and connected to the module's electric system.

The expelled air from the fan(s) 206 can exit the module housing 108 through holes 218 on some or all surfaces. The module 102 can be complemented with a CO2 supply source 114 as an additional lure, with the CO2 gas expelled through vents 216 of appropriate heights. An electric controller 212 wired to fan(s) 204 and lures such as heating pads 202 or other devices including lights can be supplied with low voltage electricity line 128 from a solar array 106 or low voltage household current 126 through a port 214.

According to an embodiment of the ovipository-seeking trapping module 104 in FIG. 3, one or more suction apertures 308 located adjacent to the water reservoir 120 can channel suctioning air flows generated by a fan or fans 302 into a catch bag, cage or other collection device 304. That collection device 304 and fan 302 can be maintained either through an access device 306 or otherwise detached for servicing and cleaning.

The expelled air from the fan 302 in module 104 can be directed over or near a lure or lures as appropriately selected and installed, maintained through a access mechanism or otherwise detachable. The expelled air can egress at port 310 into or near the water reservoir 120, resting on or beneath the ground surface. The fan(s) 302 can be supplied via line 130 with low voltage electricity from batteries, a solar array 106 or low-voltage household current 126 as appropriate.

The suction aperture(s) 308 can be sited adjacent to the water reservoir 120 at the same height. The expelled airflow via port 310, for example, including olfactory cues as lure(s) can exit adjacent to the water reservoir 120 at a distant point from the suction aperture(s) 308.

Thus, the present invention incudes a method, system, hardware and electronic devices to upgrade the trapping of biting and blood-seeking flying insects. The invention includes a novel module designed advantageously to affect the simultaneous capture of host-seeking targets that are either flying close to the ground or higher. That feature provides for trapping over a full 24 hour cycle that accommodates and exploits the behavior of host-seeking targets during daytime favoring flight close to the ground and their behavior from dusk to dawn featuring flight at a greater height.

Another novel feature is that the invention simultaneously exploits the behavior of two stages in the life cycle of target-insects; one module can trap target-insects during their host-seeking stage, while a second separate module can target gravid insects during their ovipository-seeking stage. This maximizes capture risks for target-insects by accommodating the use of the different lures and attractants such as CO2 customized for one life cycle stage or the other.

The use of modules also maximizes capture risks for target-insects by accommodating their differential locational preferences during the two life-cycle stages. Target-insects engage in host-seeking behavior prefer shady vegetation settings while those engaged in ovipository seeking behavior prefer water reservoirs sited openly in sunlight.

Another novel feature is that the module customized for host-seeking behavior can accommodate CO2 as an attractant produced by the yeast fermentation of sugars that closely mimics mammalian breath.

Advantageously, the invention can accommodate off-grid applications with an optional solar electricity capability, permitting deployment in isolated or rural settings off-grid that are proximate to concentrations of target-insects.

Advantageously, the present invention provides an improved system and method for trapping biting or blood-seeking flying insects in residential, commercial, rural, and the like, settings, and is effective concurrently at various stages of the target-insects' daily cycle, the target-insects' life cycle, and the like. Accordingly, a module to trap target-insects in their host-seeking stage, and a module to trap target-insects in the ovipository stage as gravid females seek water reservoirs in which to deposit eggs are provided.

Advantageously, potential trapping for the target insects can be maximized by the use of the modules (e.g., if both modules are utilized), and so as to provide locational flexibility reflecting differential flight habits during both the host-seeking stage and the ovipository-seeking stage, wherein target insects engaged in host-seeking behavior covet shaded vegetative environments, and gravid target insects engaged in ovipository-seeking behavior covet open, sunlit water reservoirs. During the host-seeking stage of behavior, where target insects are flying close to the ground, and also those concurrently flying higher, advantageously, the invention maximizes the trapping opportunities over an entire 24-hour period of daylight and dark.

Advantageously, trapping during the host-seeking stage utilizes a uniquely effective lure that provides a potent olfactory cue as an attractant for target-insects, wherein the lure includes CO2 having, for example, up to or more than 20 volatiles mimicking human or mammalian breath, and produced as a by-product of yeast fermentation of sugars. The invention can advantageously accommodative to the use of solar systems in off-grid applications, accommodative to dispersed or distant trapping sites, and the like, and considered target-rich environments.

Although the present invention is described in terms of a biting and of a blood-seeking insect trapping system and method, the methodology is flexible and can be implemented as modules utilized separately or in joint, as will be appreciated by those skilled in the relevant art(s).

While the present invention has been described in connection with a number of embodiments and implementations, the present invention is not so limited but rather covers various modifications and equivalent arrangements, which will fall within the purview of the appended claims.

What is claimed is:

1. A system for trapping biting or blood-seeking flying insects, comprising a host-seeking stage module configured to trap target insects in a host-seeking stage thereof, and comprising a lure including an olfactory cue configured to attract the target-insects in the host-seeking stage, and a first suction mechanism configured with suction to suck the target insects in the host-seeking stage near the lure into a first container; and
a ovipository stage module configured to trap target insects in an ovipository stage thereof, and comprising a water reservoir configured to attract gravid females seeking to deposit eggs thereon, and a second suction mechanism configured with suction to suck the gravid females from the water reservoir into a second container.

2. The system of claim 1, wherein the lure of the host-seeking stage module includes CO2 with a plurality of volatiles mimicking human or mammalian breath produced as a by-product of yeast fermentation of sugars.

3. The system of claim 1, further comprising a solar power system configured to power the first and second suction mechanisms.

4. A method for a system for trapping biting or blood-seeking flying insects, comprising trapping with a host-seeking stage module target insects in a host-seeking stage thereof, and attracting with a lure including an olfactory cue the target-insects in the host-seeking stage, and sucking with suction of a first suction mechanism the target insects in the host-seeking stage near the lure into a first container; and
trapping with a ovipository stage target insects in an ovipository stage thereof, and attracting with a water reservoir gravid females seeking to deposit eggs thereon, and sucking with suction of a second suction mechanism the gravid females from the water reservoir into a second container.

5. The method of claim 4, wherein the lure of the host-seeking stage module includes CO2 with a plurality of volatiles mimicking human or mammalian breath produced as a by-product of yeast fermentation of sugars.

6. The method of claim 4, further comprising powering with a solar power system the first and second suction mechanisms.
